(19) United States
(12) Patent Application Publication
(10) Pub. No.: US 2009/0157231 A1
(43) Pub. Date: Jun. 18, 2009

(54) WASHING MACHINE AND CONTROLLING METHOD FOR THE SAME

(76) Inventors: Gi Hyeong Do, Kyungsangnam-do (KR); Sang Il Hwang, Kyungsangnam-do (KR)

Correspondence Address: KED & ASSOCIATES, LLP, P.O. Box 221200, Chantilly, VA, 20153-1200, US

(21) Appl. No.: 12/089,834

(22) PCT Filed: Oct. 12, 2006
(86) PCT No.: PCT/KR06/04109

§ 371 Date: Sep. 11, 2008

(30) Foreign Application Priority Data
Oct. 12, 2005 (KR) 10-2005-0096132

(51) Int. Cl. G06F 1/32; G06F 1/26

(52) U.S. Cl. 700/297

(57) ABSTRACT

The present invention relates to a washing machine and a method of controlling the same. The washing machine includes a home network switch unit for selectively inputting a home network mode or a standby power mode, a standby power unit for supplying or shutting off a main power according to an operating state, and a microcomputer for controlling the standby power unit according to a mode set by the home network switch unit. Thus, the home network mode or the standby power mode is selected, if appropriate, through manipulation of a switch. Accordingly, the washing machine can be driven even when it is connected to a home network. When the standby power mode is selected, applied main power is shut off. Accordingly, there is an advantage in that a washing machine with minimized power consumption can be provided.

### TECHNICAL FIELD

The present invention relates to a washing machine and a method of controlling the same. More particularly, the present invention relates to a washing machine and a method of controlling the same, in which when a home network mode is selected, a washing machine can be driven through a home network, and when a standby power mode is selected, applied main power is shut down, thus minimizing power consumption.

### BACKGROUND ART

In general, a washing machine is provided with a standby power mode in which power consumption is 1 Watt or less in order to save power consumption when the washing machine is not used.

In order to implement standby consumption power of 1 Watt or less in the standby power mode of the washing machine, a power-off relay provided in the washing machine keeps opened. The washing machine is normally driven by temporarily driving a microcomputer using a micro switch during the standby power mode so that the power-off relay is shorted.

There is a tendency that the washing machine is connected to a home network that integrally controls electric home appliances. A recent home network is a system for integrally controlling a number of interconnected electric home appliances. Electric home appliances that can be connected to a home network are connected to a network in real-time and therefore can be implemented in a circuit always connected to power.

In the conventional washing machine, however, the power-off relay keeps opened when the washing machine is not used as described above. Accordingly, there is a problem that the conventional washing machine cannot be connected to a home network.

In other words, in order to apply the home network, electric power must be always supplied to the washing machine. Consequently, standby power is continuously consumed, which makes it difficult to save power consumption. Further, in the case where power consumption is saved using the standby power mode, the connection of the washing machine to the home network is difficult. Accordingly, a problem arises because consumer's needs to minimize standby power and to use the home network cannot be met.

### DISCLOSURE OF INVENTION

### Technical Problem

An object of the present invention is to provide a washing machine and a method of controlling the same, in which one of a home network mode and a standby power mode is selected, if appropriate, through manipulation of a switch, so that the washing machine can be driven even when it is connected to a home network, and standby power can be minimized.

### Technical Solution

To solve the above object, a washing machine according to the present invention includes a home network switch unit for selectively inputting a home network mode or a standby power mode, a standby power unit for supplying or shutting off a main power according to an operating state, and a microcomputer for controlling the standby power unit according to a mode set by the home network switch unit.

Furthermore, a method of controlling a washing machine according to the present invention includes the steps of setting one of a home network mode and a standby power mode, and when the washing machine is in an operating stop state or a power-off state, maintaining or shutting off a main power supplied to the washing machine according to a set mode.

### Advantageous Effects

In accordance with a washing machine and a method of controlling the same according to the present invention, the washing machine is driven according to one of a home network mode and a standby power mode selected through manipulation of a switch. When the standby power mode is selected, applied main power is shut off to minimize power consumption, and data transmission/reception from a connected home network and an operation accordingly are performed. Accordingly, there are advantages in that power consumption can be saved and control through the home network is convenient.

### BRIEF DESCRIPTION OF THE DRAWINGS

FIG. 1 is a block diagram showing the construction of a washing machine according to the present invention;

FIG. 2 is a circuit diagram of a home network switch unit of the washing machine according to the present invention; and

FIG. 3 is a flowchart illustrating a method of operating the washing machine according to the present invention.

### BRIEF DESCRIPTION OF THE DRAWINGS

10: microcomputer 20: power supply unit

30: standby power unit 40: home network switch

50: motor driver 60: motor

70: memory

### BEST MODE FOR CARRYING OUT THE INVENTION

The present invention will now be described in detail in connection with a specific embodiment with reference to the accompanying drawings.

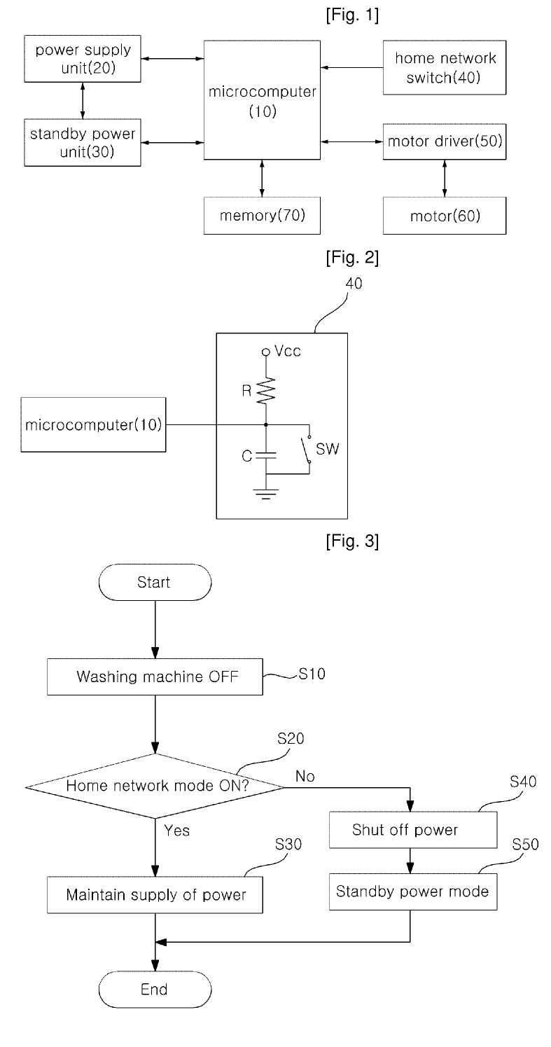

FIG. 1 is a block diagram showing the construction of a washing machine according to the present invention.

The washing machine according to the present invention includes a power supply unit 20 for supplying electric power, a home network switch unit 40 for selecting a home network mode or a standby power mode, a standby power unit 30 for controlling the supply of a main power supplied from the power supply unit 20 according to a mode set in the home network switch unit 40, a microcomputer 10 for controlling the standby power unit 30 in response to a signal generated when the home network switch unit 40 is manipulated, a motor driver 50 for driving a motor 60 under the control of the microcomputer 10, the motor 60 for rotating a drum or washing tub under the control of the motor driver 50, and memory 70 for storing setting in the home network switch unit 40.

The power supply unit 20 is connected to an external power supply, and supplies operating power for driving the washing machine. In this case, the power supply unit 20 rectifies externally input electric power and supplies rectified power.

The home network switch unit 40 serves to select one of the home network mode and the standby power mode, and applies a signal, corresponding to a selected mode, to the microcomputer 10.

The microcomputer 10 controls the operation of the standby power unit 30 according to the home network mode and the standby power mode in response to the signal received from the home network switch unit 40. In this case, the microcomputer 10 controls the standby power unit 30 to turn on/off the main power.

If the home network mode or the standby power mode is selected and a corresponding signal is received from the home network switch unit 40, the microcomputer 10 controls the standby power unit 30, and at the same time, stores set data corresponding to the received signal in the memory 70 and controls status information about a selected mode based on the stored set data to be display through display means provided in the washing machine.

If the standby power mode is selected in the home network switch unit 40, the standby power unit 30 shuts off the main power supplied to drive the washing machine when the operation of the washing machine is stopped or the power of the washing machine is off.

If a specific signal is received, the standby power unit 30 temporarily supplies electric power to the microcomputer 10. At this time, if the microcomputer 10 is driven by temporarily supplied electric power, the microcomputer 10 controls the standby power unit 30 to supply normal electric power to the washing machine so that the washing machine is driven.

If the main power is shut off by the standby power unit 30 as described above, electric power is not supplied to the microcomputer 10, and therefore the washing machine consumes power of 1 Watt or less.

Meanwhile, if the home network mode is selected in the home network switch unit 40, the standby power unit 30 maintains the supply of the main power without shutting off the main power supplied to the washing machine although the operation of the washing machine is stopped or the power of the washing machine is off according to the control signal of the microcomputer 10.

The standby power unit 30 includes a standby power switch (not shown), and turns on/off the standby power switch according to the control signal of the microcomputer 10 so that the main power supplied from the power supply unit 20 is supplied or shut off. In this case, the standby power switch preferably includes a power shut-off relay, but may include switches that can be turned on/off.

That is, if the home network switch unit 40 is set to the standby power mode, the standby power unit 30 turns off the standby power switch according to the control signal of the microcomputer 10 when the operation of the washing machine is stopped or the power of the washing machine is off, so that the supply of the main power is shut off. If the home network switch unit 40 is set to the home network mode, the standby power unit 30 maintains the on state of the standby power switch according to the control signal of the microcomputer 10 although the operation of the washing machine is stopped or the power of the washing machine is off, so that the main power is supplied to the washing machine.

The motor driver 50 is controlled by the microcomputer 10, and drives the motor 60 to operate the washing machine. The motor 60 is driven by electric power supplied from the motor driver 50 and under the control of the motor driver 50, and rotates a drum or washing tub.

The construction of the home network switch unit 40 is described in more detail below.

FIG. 2 is a circuit diagram of a home network switch unit of the washing machine according to the present invention.

The home network switch unit 40, as illustrated in FIG. 2, includes a switch SW to which one of the home network mode and the standby power mode is input, a capacitor C connected in parallel to the switch SW, and a resistor R connected in series to the capacitor.

The resistor R has one end connected to an operating voltage VCC and the other end connected to the capacitor C. The capacitor C has one end connected to the resistor R and the other end grounded (GND), and has both ends connected in parallel to the switch SW. A node at which the resistor R and the capacitor C are connected is connected to the microcomputer 10, so that a signal depending on on/off manipulation of the switch SW is applied to the microcomputer 10.

The switch SW of the home network switch unit 40 is only an embodiment of a device for selecting and inputting one of the home network mode and the standby power mode, and is not limited to one illustrated in the drawing. The home network switch unit 40 may include a switch and a relay, which can be turned on/off in order to select a mode. Further, the home network switch unit 40 may be implemented to select a mode as at least one button is consecutively manipulated or at the same time.

At this time, as the switch SW of the home network switch unit 40 is turned on/off, the home network mode or the standby power mode is selected and input, and a corresponding signal is transmitted to the microcomputer 10.

In other words, if the switch SW of the home network switch unit 40 is turned on, a signal indicating that the home network mode has been selected is transmitted to the microcomputer 10. At this time, the microcomputer 10 applies a control signal to the standby power unit 30 in response to the signal received from the home network switch unit 40, and sets the home network mode accordingly. The standby power unit 30 turns on the standby power switch according to the control signal of the microcomputer 10 so that the main power is supplied even when the operation of the washing machine is stopped or the power of the washing machine is off.

Meanwhile, if the switch SW of the switch unit 40 is turned off, the microcomputer 10 controls the standby power unit 30 to turn off the standby power switch when the operation of the washing machine is stopped or the power of the washing machine is off, so that the washing machine is set to the standby power mode.

The operation of the washing machine constructed above according to the present invention is described below.

FIG. 3 is a flowchart illustrating a method of operating the washing machine according to the present invention.

As illustrated in FIG. 3, if the power of the washing machine is off or the operation of the washing machine is stopped at step S10, the home network switch unit 40 is manipulated to set one of the home network mode and the standby power mode. In this case, if the switch SW of the home network switch unit 40 is turned on, the home network mode is set, and the switch SW of the home network switch unit 40 is turned off, the standby power mode is set.

In the case where the home network switch unit 40 is turned on and the home network mode is selected accordingly at step S20, the supply of the main power for the operation of the washing machine is maintained by the standby power unit 30 even when the power of the washing machine is off at step S30.

Accordingly, even when the power of the washing machine is off or the operation of the washing machine is stopped, the main power is supplied to the washing machine as described above. Thus, data transmission/reception through a network connected to the washing machine is possible, enabling the operation of the washing machine to be controlled by a home network function.

Meanwhile, in the case where the home network switch unit 40 is turned off and the standby power mode is selected accordingly, the supply of the main power to the washing machine is shut off by the standby power unit 30 in a state where the power of the washing machine is off as described above at step S40.

As the supply of the main power is shut off by the standby power unit 30, the washing machine becomes the standby power mode and can consume power consumption of 1 Watt or less S50.

Therefore, in accordance with a washing machine and a method of driving the same according to the present invention, a mode is switched through manipulation of the home network switch unit 40. Thus, the washing machine can be easily switched to one of the home network mode and the standby power mode. Accordingly, consumers' needs to save power consumption of a washing machine and to apply the washing machine to a home network can be met.

### INDUSTRIAL APPLICABILITY

In accordance with a washing machine and a method of driving the same according to the present invention, the washing machine can be easily switched to one of a home network mode and a standby power mode. Accordingly, there are advantages in that the present invention can be applied to a variety of network environments and can save power consumption through a standby power mode.

1. A washing machine comprising:
a home network switch unit for selectively inputting a home network mode or a standby power mode;
a standby power unit for supplying or shutting off a main power according to an operating state; and
a microcomputer for controlling the standby power unit according to a mode set by the home network switch unit.

2. The washing machine as claimed in claim 1, wherein the standby power unit comprises a standby power switch for shutting off the main power when an operation of the washing machine is stopped or power of the washing machine is off so that the washing machine switches to the standby power mode.

3. The washing machine as claimed in claim 1, wherein the home network switch unit comprises a switch for selectively inputting one of the home network mode and the standby power mode, and transferring a signal corresponding to a mode selected by manipulating the switch to the microcomputer.

4. The washing machine as claimed in claim 3, wherein the home network switch unit further comprises:
a capacitor connected in parallel to the switch, and
a resistor having one end connected in series to the switch and the capacitor, and the other end connected to an operating voltage.

5. The washing machine as claimed in claim 3, wherein the home network switch unit comprises one of a switch, a relay and at least one button so that one of the home network mode and the standby power mode is selectively input.

6. The washing machine as claimed in claim 2, wherein if the home network switch unit is set to the home network mode, the microcomputer controls the standby power switch to maintain the main power without switching to the standby power mode although the power of the washing machine is off.

7. A method of controlling a washing machine, comprising the steps of:
setting one of a home network mode and a standby power mode; and
when the washing machine is in an operating stop state or a power-off state, maintaining or shutting off a main power supplied to the washing machine according to a set mode.

8. The method as claimed in claim 7, wherein:
if the home network mode is set, the supply of the main power is maintained when the washing machine is in an operating stop state or a power-off state, and
if the standby power mode is set, the supply of the main power is shut off when the washing machine is in an operating stop state or a power-off state.
